(19) United States
(12) Patent Application Publication
(10) Pub. No.: US 2021/0354064 A1
(43) Pub. Date: Nov. 18, 2021

(54) Antimicrobial and Antiviral Protective Barrier

(71) Applicants: Kenneth Herbert Keuchel, Cuyahoga Falls, OH (US); Connor Ayrom Keuchel, Cuyahoga Falls, OH (US); Brennen Ayrom Keuchel, Cuyahoga Falls, OH (US); Destynn Ayrom Keuchel, Cuyahoga Falls, OH (US)

(72) Inventors: Kenneth Herbert Keuchel, Cuyahoga Falls, OH (US); Connor Ayrom Keuchel, Cuyahoga Falls, OH (US); Brennen Ayrom Keuchel, Cuyahoga Falls, OH (US); Destynn Ayrom Keuchel, Cuyahoga Falls, OH (US)

(21) Appl. No.: 17/322,278

(22) Filed: May 17, 2021

Related U.S. Application Data
(60) Provisional application No. 63/101,793, filed on May 16, 2020.

(51) Int. Cl. B01D 39/16; B01D 46/52; B01D 46/00; B32B 5/02; B32B 5/26

(52) U.S. Cl. CPC B01D 39/1623; B32B 2307/724; B01D 46/0032; B01D 46/0028; B32B 5/022; B32B 5/028; B32B 5/265; B01D 2239/0618; B01D 2239/0622; B01D 2239/0435; B01D 2239/0442; B01D 2239/065; B32B 2250/03; B32B 2250/40; B32B 2262/0253; B32B 2307/20; B32B 2307/7145; B01D 46/521

(57) ABSTRACT

A protective barrier having antimicrobial and antiviral properties. The protective barrier comprises a filtration media structure. The filtration media structure comprises inner melt blown nonwoven filtration media, an outer melt blown nonwoven filtration media, and a channeling layer. The channeling layer is sandwiched between the inner and outer filtration media layers. The channeling layer comprises a plurality of filaments. Each filament is constructed having a non-round cross-section. The filaments are arranged in a three-dimensional (3D) structure configured to disturb laminar flow through the protective barrier. The protective barrier may further comprise an inner layer and an outer layer encapsulating the filtration media structure.

### CROSS-REFERENCE TO RELATED APPLICATION

The present application claims priority to, and the benefit of, U.S. Provisional Application No. 63/101,793, which was filed on May 16, 2020 and is incorporated herein by reference in its entirety.

### FIELD OF THE INVENTION

The present invention generally relates to a protective barrier, and more specifically to a protective barrier for use in a medical mask or other protective covering constructed with antimicrobial and antiviral properties. Accordingly, the present specification makes specific reference thereto. However, it is to be appreciated that aspects of the present invention are also equally amenable to other like applications, devices, and methods of manufacture.

### BACKGROUND OF THE INVENTION

Germs, bacteria, viruses, microbes, and other pathogens are microscopic living things that exist throughout nature. A pathogen is a type of micro-organism that has the potential to cause disease. Microbes are too small to be seen by the naked eye. Microbes are found in water, soil, and in the air. Some microbes cause illness or disease while others are important for good health. The most common types of microbes are bacteria, viruses, and fungi. A predominant rout of entry into the body is by introducing these pathogens and organisms by inhalation or through mucus membranes. Personal protective equipment, such as a face mask can provide some protection from infection from dangerous micro-organisms.

Viruses are a frequent cause of many infectious diseases. Viruses are made up of one or more molecules surrounded by a protein shell. Transmission of a virus typically occurs directly from person to person, most commonly by inhalation. Some forms of viruses are harmless and only trigger a minor cold, while others can cause serious diseases such as COVID-19 caused by a coronavirus called SARS-CoV-2, influenza, varicella, mumps, measles, and viral meningitis. These viruses are typically spread through respiratory droplets produced when an infected person coughs or sneezes. These droplets can land in the unprotected mouths or noses of people and be inhaled into the lungs. The spread of viruses is more common when people are in close proximity without any protective barrier in place. Face masks are the primary physical barrier typically used to decrease or prevent this type of airborne virus transmission.

Disinfectants and sanitizing agents are used to control transmission of dangerous pathogens in indoor environments. Disinfectants and sanitizers have proven effective at reducing disease causing microorganisms that cause illness on a surface. Unfortunately, the cleaning effect of disinfectants and sanitizers is short lived, being limited to the point when recontamination of the surface occurs or the effective time of the disinfecting or sanitizing agent used. Once a surface is contaminated again, the pathogens will continue to survive until the area is disinfected again. Cloth, or plastic fiber based personal protective equipment (PPE) such as face masks or surgical gowns are not well suited to disinfecting or sanitizing agent due to their construction.

Copper is a known inherently antimicrobial material. Copper has the ability to alter the 3-dimensional structure of proteins, form radicals that inactivate viruses, disrupt enzyme structure, interfere with essential elements of a cell, facilitate deleterious activity in superoxide radicals, disturb cell wall permeability causing nutrient uptake to fail, and impair cellular metabolism. It is well known that copper is a preferred antimicrobial material.

Medical face masks and barriers are designed to protect a user against contamination from air-borne bacteria, pathogens, particulates, and the like by minimizing the number of air-borne bacteria or pathogens that can penetrate the mask and be inhaled. The current typical construction of medical masks is a three layer barrier. There are inner and outer layers sandwiching a filtration media. The inner and outer layers are nonwoven moisture resistant plastics while the filtration media is designed to stop the transmission of larger pathogen particles.

Accordingly, there is a great need for an improved protective barrier constructed for use in a medical face mask or other protective barrier configured to better prevent inhalation of harmful air-borne pathogens and viruses. There is also a need for an improve protective barrier constructed with antiviral and antimicrobial properties effective against smaller airborne pathogens transmitted by droplets. Similarly, there is a need for a medical mask constructed from a protective barrier configured with additional surface area for antimicrobial and antiviral materials. Further, there is a need for a need for an antiviral and antimicrobial barrier that does not adversely restrict airflow to a user.

In this manner, the antiviral and antimicrobial barrier of the present invention accomplishes all of the forgoing objectives, thereby improving protection against dangerous microbes and viruses. A primary feature of the present invention is a protective barrier constructed with antiviral and antimicrobial properties effective against smaller airborne pathogens that are transmitted by droplets. The present invention increases the surface area of antimicrobial and antiviral materials used in a multi-layer medical face mask or other protective barrier device. Finally, the improved protective barrier of the present invention is capable of reducing inhalation of harmful air-borne pathogens and viruses while not interfering with breathing when used to construct medical face masks.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a protective barrier. The protective barrier is configured to filter out airborne particles. The protective barrier comprises a filtration media structure. The filtration media structure comprises a first filtration media layer and a second filtration media layer. The first and second filtration media layers may be constructed from melt blown nonwoven material. The first and second filtration media layers may have similar or different weights. The inner filtration media layer may be lighter than the outer filtration media layer or vice versa.

The filtration media structure further comprises a channeling layer. The channeling layer comprises a plurality of filaments and is sandwiched between the inner and outer filtration media layers. Each filament is constructed having a round or non-round cross-section, such as a plus-shape cross-section. The filaments are arranged in a three-dimensional (3D) structure that is configured to disturb laminar flow through the protective barrier.

The channeling layer may be electret treated to attract particles penetrating the protective barrier. The channeling layer may further comprise an antimicrobial additive. The antimicrobial additive is attachable to the plurality of filaments. The antimicrobial additive may comprise an antimicrobial effective amount of cuprous oxide, copper-silver ion, or other antimicrobial agents. The antimicrobial additive may also be attached to or otherwise incorporated into any of the filtration media layers as well.

The protective barrier may further comprise an inner layer and an outer layer. The inner and outer layers may be constructed from a nonwoven polypropylene enhanced with antimicrobial content. The filtration media structure is sandwiched between the inner and outer layers. The inner and outer layers may be the same weight or of different weights.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic view demonstrating air flow through a protective barrier of the present invention in accordance with the disclosed architecture.

FIG. 2 illustrates a cross-sectional view of a filament having a round cross-section typically used to construct filtration media for a medical face mask in accordance with the disclosed architecture.

FIG. 3 illustrates a cross-sectional view of a filament having a plus-shaped cross-section used to construct a filtration media structure of the protective barrier of the present invention in accordance with the disclosed architecture.

FIG. 4A illustrates a cross-sectional view of the filament having the plus-shaped cross-section used to construct the filtration media structure of the protective barrier of the present invention in accordance with the disclosed architecture.

FIG. 4B illustrates a cross-sectional view of a filament having a non-round cross-section used to construct the filtration media structure of the protective barrier of the present invention in accordance with the disclosed architecture.

FIG. 4C illustrates a cross-sectional view of a filament having a non-round cross-section used to construct the filtration media structure of the protective barrier of the present invention in accordance with the disclosed architecture.

FIG. 5 illustrates a diagrammatic view demonstrating laminar flow of air around a plurality of filaments having the round cross-section typically used to construct filtration media in accordance with the disclosed architecture.

FIG. 6 illustrates a diagrammatic view demonstrating laminar flow of air around the plurality of filaments having the plus-shaped cross-section used to construct the filtration media structure of the protective barrier of the present invention in accordance with the disclosed architecture.

FIG. 7 illustrates a perspective view of the plurality of filaments arranged in a three-dimensional (3D) structure of the protective barrier of the present invention in accordance with the disclosed architecture.

FIG. 8 illustrates a perspective view of an antimicrobial additive attached to the plurality of filaments arranged in the 3D structure of the protective barrier of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

Typical medical or surgical masks are manufactured having three layers. An outer barrier layer is constructed of a nonwoven polypropylene, a filtration media layer typically constructed from a melt blown polypropylene electret treated to enhance hydrophilic properties and attract particles, and an inner layer closer to the face constructed of nonwoven polypropylene again.

Antimicrobial and antiviral additives for plastics work via one of two mechanisms. First, the chemical used for the antimicrobial and antiviral properties can slowly leach out replenishing its surface antimicrobial and antiviral properties until the leaching process is exhausted. This is a time limited process. The second form relies on the bacteria or virus to physically contact the antimicrobial and antiviral material utilizing a dispersion within a matrix material. This process is similar to adding carbon black powder in a thermoplastic to make it black in color. When contact occurs, the bacteria or virus is neutralized because a certain amount of the additive is on the surface of the matrix material.

In the case of medical masks, the matrix material is commonly polypropylene. Additives for thermoplastics for antimicrobial properties such as Microban® are known. Triclosan along with anti-microbial anti-bacterial additive has been successfully used against Methicillin-resistant Staphylococcus aureus (MRSA). Similarly, silver and other metal additives such as copper have been shown to have antimicrobial properties. An anti-viral additive that requires direct physical contact could be similarly disbursed into the fibers of a face mask, or other protective apparel.

Unfortunately, it is challenging to place additives that require direct physical contact with a microbe, bacteria, or virus to be effective directly in the path of the target. In the case of medical masks, the filaments used to create the layers are round in shape. These round filaments allow air to flow around them during inhalation and exhalation. As such, the surface area efficiency of the nonwoven round filament polymer has the lowest surface area per weight ratio.

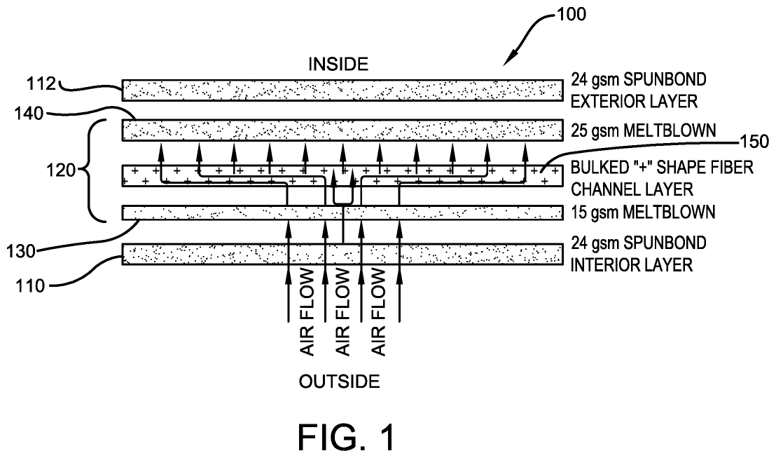

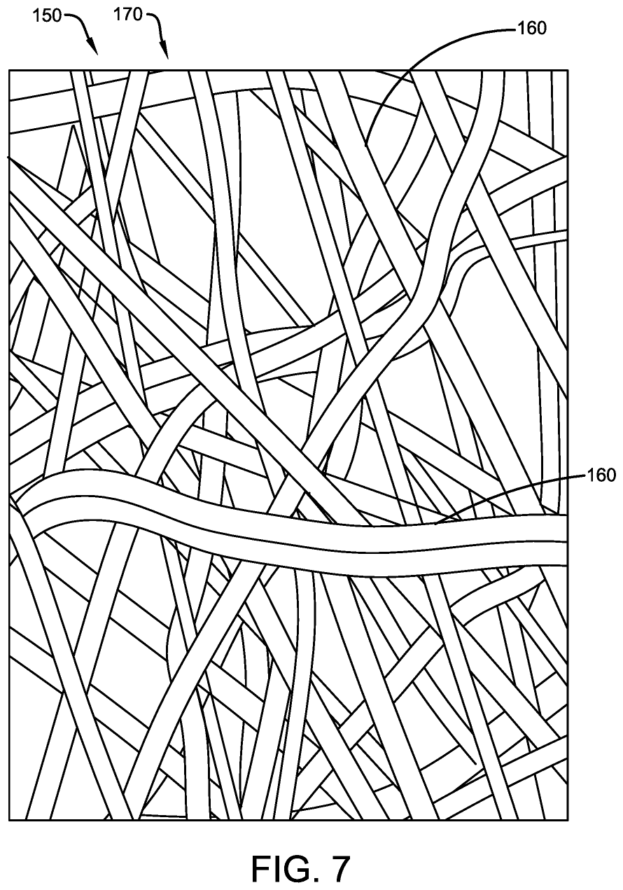

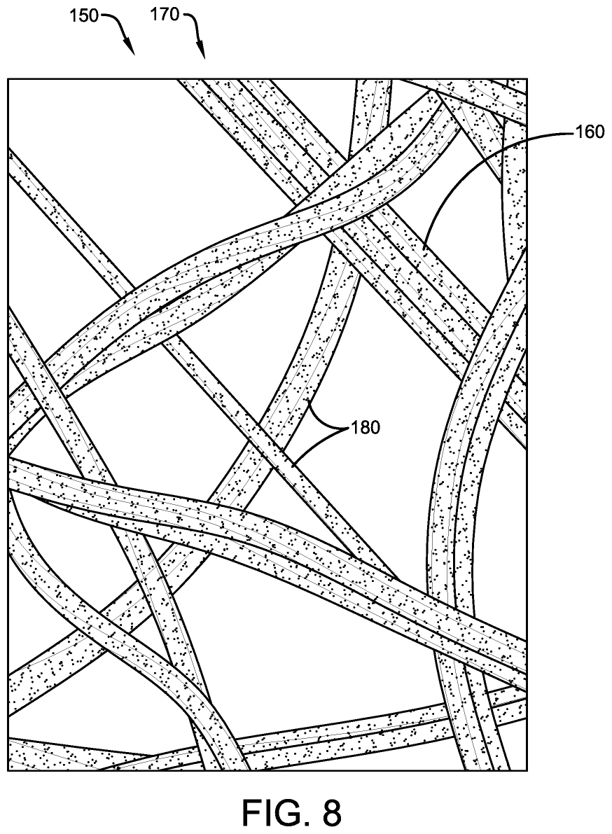

Referring initially to the drawings, FIGS. 1-8, the present invention, in one exemplary embodiment, is a protective barrier 100. The protective barrier 100 is constructed with an increased surface area nonwoven polymer fiber barrier for improving direct contact of the fiber surface during airflow. The increased surface area allows for better physical contact between microbes, bacteria, or viruses and the filter material so that an antimicrobial additive on the fiber surfaces can be most effective.

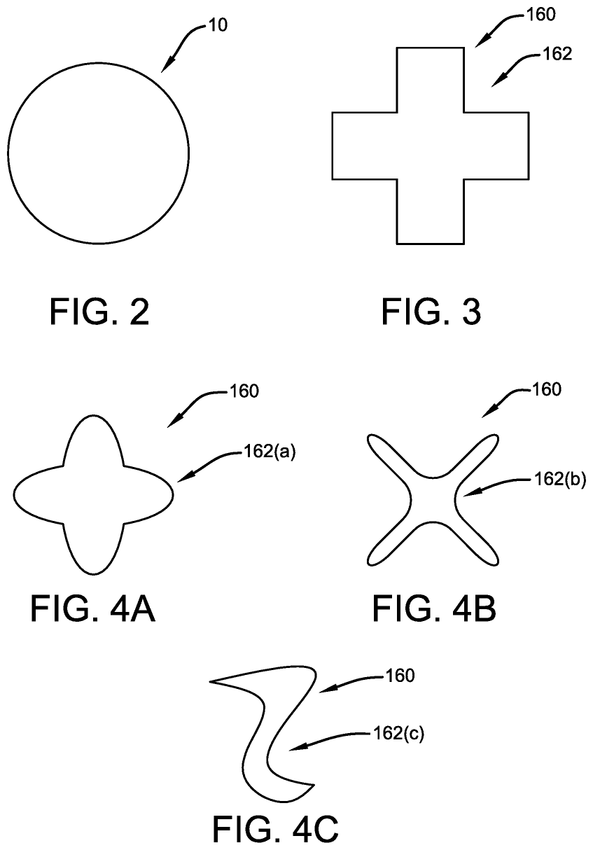

FIG. 2 illustrates an example of a typical fiber 10 used in barrier masks with a round shape or cross-section. To improve the overall surface area available to come in contact with a target bacteria or virus, a shape other than round is preferred, such as a non-round cross-section fiber 162 as illustrated in FIG. 3. In this example, the perimeters of both fibers are different. The perimeter of the plus shaped cross-section fiber 162 of FIG. 3 is approximately 50% larger than the round cross-section fiber filament 10 of FIG. 2, and when multiplied by the equivalent length, would yield a greater surface area of the filament.

The protective barrier 100 is configured to filter out airborne particles including bacteria, viruses, and other microbes. The protective barrier 100 comprises a filtration media structure 120. The filtration media structure 120 comprises a first filtration media layer 130 and a second filtration media layer 140. The first and second filtration media layers 130 and 140 may be constructed from a melt blown nonwoven material, such as melt blown polypropylene. A melt blown nonwoven material is a material manufactured using a nonwoven manufacturing system involving direct conversion of a polymer into substantially continuous fine filaments, integrated with the conversion of the filaments into a random laid nonwoven fabric.

The first and second filtration media layers 130 and 140 may alternatively be constructed from nano nonwovens which are typically formed with electrostatic deposition which are highly breathable. There can be other methods to make the media layers. If the melt blown layer also had lobed filament shape, its performance may also be enhanced. The antimicrobial may be incorporated into the melt blown layers with the increased surface area filaments as another enhancement. The first and second filtration media layers 130 and 140 may have similar or different weights. The inner filtration media layer 130 may be lighter than, heavier than, or the same weight as the outer filtration media layer 140. A basis weight of each of the inner and outer melt blown nonwoven filtration media layers 130 and 140 typically ranges from 2 to 80 g/m². It can also be made more open and breathable. Nano nonwoven has shown effectiveness down to 2 g/m². Alternatively, reticulated films with small pores may also be used. This is advantageous for protective barrier applications other than masks, such as medical gowns, disposable floor mats, runners, medical drapes, and the like where reducing surface contact or vapor transmission of microbes is important.

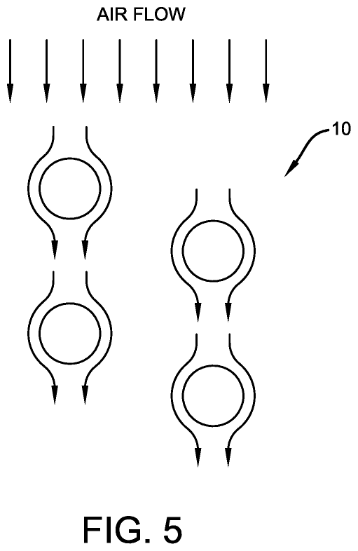

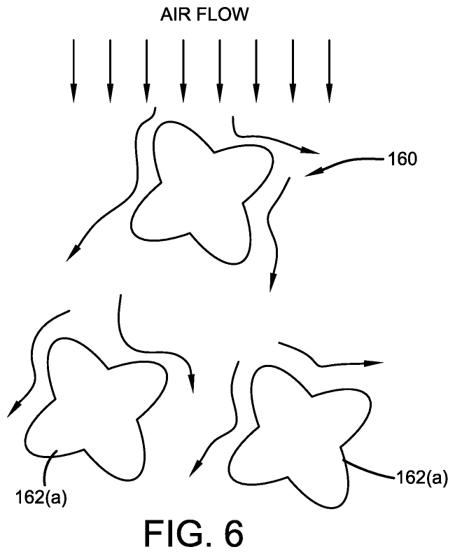

The filtration media structure 120 further comprises a channeling layer 150. The channeling layer 150 comprises a plurality of filaments 160 and is sandwiched by or encapsulated between the inner and outer filtration media layers 130 and 140. Each filament 160 is constructed having a non-round cross-section 162. The non-round cross-section 162 may comprise a plus-shape cross-section 162(a) as illustrated in FIG. 4A. The non-round cross-section 162 may alternatively comprise additional non-round cross-sectional filaments 162(b) and 162(c) as illustrated in FIGS. 4B and 4C. Alternatively, each filament 160 may be constructed having a coarse round cross-section 10 with an open and large filament structure as described infra.

The “lobed” or “plus-sign” cross section of the plus-shape cross-section 162(a) filament 160 increases the surface area per weight ratio in comparison to a round cross-section filament 10. Advantageously, this cross-section shape disturbs the laminar flow path around the plurality of filaments 160, deflecting the airborne particulates like a pachinko machine as illustrated in FIG. 6. The deflection of the laminar flow effectively increases direct contact between the filaments 160 and the airborne particles. For comparison, the round cross-sectional filaments 10 produce a more substantially parallel airflow, thereby decreasing direct contact of the filaments 160 with airborne particles as illustrated in FIG. 5 as opposed to a more scattered path airflow.

The filaments 160 are preferably arranged in a three-dimensional (3D) structure 170 that is configured to disturb laminar air flow through the protective barrier 100. The 3D structure 170 may be an open fiber structure, an extruded 3D mesh, pleats, or the like, or any other similar open structure constructed for flow enhancement that allows air to flow less restrictively. The 3D structure 170 is particularly effective at altering airflow when applied between the two layers of the melt blown filtration media 130 and 140.

As illustrated in FIG. 1, placing the plus-shape cross-section 162(a) filaments 160 between the two layers of melt blown nonwoven 130 and 140 creates an unexpected combination of effects. First, the surface area available for direct contact with airborne particles with the plus-shape cross-section 162(a) filaments 160 is increased. This allows the antimicrobial rich filaments 160 a better opportunity to make contact with airborne microbes. This is especially important when there is any antimicrobial that required direct contact with microbes to be effective as discussed infra. Second, this configuration offers a superior 3D shape that allows more air volume between the two layers 130 and 140 as the channeling layer 150 creates a gap between the two layers 130 and 140. Additionally, providing the channeling layer 150 enhances breathability and air distribution between the filtration media layers 130 and 140, which can also enhance particle filtration efficiency. This shape configuration, which improves available surface area contact and disturb laminar flow, can be effective in any of the layers deployed.

The channeling layer 150 may be electret treated to better attract particles penetrating the protective barrier 100. Electret treatment of the surfaces, to attract a bacteria, microbe or virus, is advantageous by making the channeling layer 150 more hydrophilic to attract and maintain contact with a water containing particle. A particle filtration efficiency test using salt powder was used in testing. A liquid dispersion is aerosolized, then the droplets are dried to make solid salt particles of a certain size range. As illustrated in FIG. 8, the channeling layer 150 may further comprise an antimicrobial additive 180. The antimicrobial additive 180 is attachable to the plurality of filaments 160. The antimicrobial additive 180 may comprise an antimicrobial effective amount of cuprous oxide, silver, copper-silver ion, or other antimicrobial additives. Combining the antimicrobial additive 180 with the multi-lobed filaments is unique.

As such, the gap created by the channeling layer 150 between the two layers 130 and 140 is an antimicrobial gap as the two layers 130 and 140 are physically separated. The two layers of melt blown nonwoven 130 and 140 may also be constructed from non-round cross-section 162 filaments that may be treated with the antimicrobial additive 180. Additionally, the channeling layer 150 may be separated into a plurality of layers itself to create additional antimicrobial gaps. The “gapping” of the filtration media layers with either just antimicrobial or antimicrobial and flow enhancing or just flow enhancing creates an antimicrobial separation of the layers that effectively decreases surface migration through the layers. This is important as it separates the surface contamination, either from the outside from infecting agents, or from the inside out from an infected patient.

The protective barrier 100 may further comprises an inner layer 110 and an outer layer 112. The inner and outer layers 110 and 112 may be constructed from a nonwoven or spunbond polypropylene. The filtration media structure 120 is sandwiched between the inner and outer layers 110 and 112. The inner and outer layers 110 and 112 may have similar or different weights. The inner layer 110 may be lighter than, heavier than, or the same weight as the outer layer 112. The inner and outer layers 110 and 112 may also be constructed from non-round cross-section 162 filaments that may be treated with the antimicrobial additive 180.

In an additional embodiment, the protective barrier may comprise a barrier structure. The protective barrier may be a film or similar barrier well suited to splash protection. The barrier structure may be constructed from a nonwoven or spunbond polypropylene. The barrier structure comprises a plurality of filaments each having a non-round cross-section arranged in a three-dimensional (3D) structure. The protective barrier further comprises an antimicrobial additive. The antimicrobial additive is attachable to the plurality of filaments as in previous embodiments to improve antimicrobial contact. The barrier structure may also be electret treated.

The barrier structure may comprise an inner layer and an outer layer attached to the inner layer. The inner and outer layers are constructed with the plurality of filaments each having a non-round cross-section arranged in a three-dimensional (3D) structure. The barrier structure may further comprise a media structure sandwiched between the inner and outer layers. The media structure comprises a first melt blown nonwoven media layer, a second melt blown nonwoven media layer, and a channeling layer sandwiched between the first and second melt blown nonwoven media layers similar to previous embodiments.

This five layer minimum construction using the flow enhanced plus-shaped fibers with antimicrobials significantly improves particle filtration efficiency. With the inner and outer layers separated by the antimicrobial flow enhancing layer, surface transmission from one filtration layer to another through surface transmission contact is mitigated. Advantageously, the inner and outer layers, which incorporate antimicrobial, reduce surface bacterial growth, which on the outside would reduce contact transmission from touching the outer surface, and on the inside, within the moist warm environment of long term use, would reduce the breeding of bacteria on that inner surface. The protective barrier 100 on the outside mechanically protects the very fragile filtration media below and is used more to offer abrasion resistance. In this case, using the non-round filament shapes and antimicrobial additives provide some antimicrobial/antiviral filtration, but also antimicrobial/antiviral surface contact reduction. If someone were to touch or adjust the protective barrier, the microbes on the surface of the fibers would be significantly dead. This reduces contact transmission by hand contact.

In one example, Table 1 illustrates the effect of adding the flow enhancement layer between the two melt blown filtration media layers, and the result on salt particle filtration efficiency and breathability, tested on a Palas PMFT 1000 particle filtration efficiency tester set-up for the NIOSH 42CFR84 testing standard.

TABLE 1

| | |
|---|---|
| Particle Filtration Efficiency | |
| (NIOSH 42 CFR84) | Breath Resistance (NIOSH 42CFR84) |

| | | Particle | | Differential | Differential |
|---|---|---|---|---|---|
| | Number | Filtration | Number | Pressure | Pressure |
| Sample | of samples | efficiency | of samples | (inhalation) | (exhalation) |
| Composition | tested | result | tested | Target < 343 Pa | Target < 245 Pa |
| 20 g/m² melt | 5 | 95.6 | | | |
| blown × 2 | | | | | |
| 15 g/m²/ | 6 | 96.9 | 3 | 125 | 118 |
| D0259Z/25 | | | | | |
| g/m² | | | | | |

When placing the flow enhancement layer between two layers of filtration media, there was a difference when the two melt blown layers were at different weights. During experimentation, weights of 15 and 25 g/m² were used. Keeping the 15 g/m² on the outside of the mask, air flowed through the 15 g/m² layer, hits the air flow enhancement media, and distributes over a larger area. This increase in area distribution does two things: distributes the filtration over a larger area, decreasing the air velocity over a single layer media, and deflects the air flow path to more of a scatter, which can enhance particle filtration efficiency.

In another example, Table 2 illustrates data from masks that were made with the same 27 g/m² spun bond outer layers, and the same 15 g/m² and 25 g/m² melt blown filter media and were tested on a Palas PMFT 1000 particle filtration efficiency tester. All tests were conducted on the same day that the masks were made. The testing script used was the NIOSH 42CFR84 using an aqueous 5% NaCl solution neutralized via corona discharge unit, as required by the NIOSH standard. The first mask construction with no air flow media enhancement layer had the 15 g/m² melt blown media layer on top of a 25 g/m² melt blown media layer, with the 25 g/m² melt blown closest to the face. The second sample used a D0259L flow enhancement nonwoven layer made by Spunfab, Ltd, with round filaments at 12 g/m². The Third mask used a layer of 12 g/m² D0259M flow enhancement made by Spunfab, Ltd using plus-shaped fibers. A total of six samples of each construction was used for the particle filtration efficiency testing and for air flow resistance a set of three. The results from the tests have two interesting outcomes. First, the particle filtration efficiency increased from 92.2% for the round flow enhancement layer to 94.5% for the flow enhancement layer with the plus-shaped fibers. Also, of note is that this data set also had the closest standard deviation for particle filtration efficiency at 1.5. Second, the pressure drop on the inhalation portion of the test went from 143.3 Pa for the layers with no flow enhancement nonwoven layer down to 127.2 Pa with the D0259M with the plus shaped fibers. Reduced pressure drop leads to a more breathable mask.

TABLE 2

| | Particle Filtration | | | Breath resistance (NIOSH | | | |
|---|---|---|---|---|---|---|---|
| | Efficiency -NIOSH 42CFR84) | | | 42CFR84 | | | |
| | | Efficiency | | | Differential | Differential | Flow Media |
| | | (85 L/min | | | Pressure | Pressure | Thickness |
| | No | main air) | St. | No. | (inhalation) | (exhalation) | (microns, 10 |
| Subject | samples | (Target > 95.00) | Dev | samples | Target < 343 Pa | Target < 245 Pa | measurements) |
| CONSTRUCTIONS | | | | | | | |
| (FINISHED MASKS) | | | | | | | |
| 27 g/m² | 6* | 92.6* | 2.2* | 3 | 143.4 | 116.1 | N/A |
| spunbond/15 | | | | | | | |
| g/m² mb/25 | | | | | | | |
| g/m² mb/27 g/m² | | | | | | | |
| spunbond | | | | | | | |
| 27 g/m² | 6* | 92.2* | 4.6* | 3 | 129.7 | 110.7 | 204.0 |
| spunbond/15 | | | | | | | |
| g/m² mb/ | | | | | | | |
| D0259L (round | | | | | | | |
| filaments) 12 | | | | | | | |
| g/m²/25 g/m² | | | | | | | |
| mb/27 g/m² | | | | | | | |
| spunbond | | | | | | | |
| 27 g/m² | 6* | 94.5* | 1.5* | 3 | 127.1 | 109.3 | 263.9 |
| spunbond/15 | | | | | | | |
| g/m² mb/ | | | | | | | |
| D0259M (plus | | | | | | | |
| filaments) 12 | | | | | | | |
| g/m²/25 g/m² | | | | | | | |
| mb/27 g/m² | | | | | | | |
| spunbond | | | | | | | |

*indicates sample was challenged with a neutralized aerosol. Tests used 5% NaCl solution.

The Palas PMFT 1000 detector actually measures the amount of salt particles that are penetrating through the sample. To achieve a 92.2% particle filtration efficiency, the amount of penetration of particles was 7.8%. The amount of penetration of the mask made with the plus-shaped fiber flow enhancement layer, was measured to be 5.5% penetration. If one were to consider the amount of improvement, with the maximum potential of 0% penetration, the 2.3% improvement from 7.8 to 5.5% penetration represents a reduction in penetration of 29%, using the same melt blown filtration media. Combine the filtration efficiency improvement with the higher breathability (lower pressure drop across the layers of the mask) yields a higher-performing mask with the novel placement of a flow enhancing layer. This layer may actually scatter the salt particles, with its plus-shaped cross section, increasing the length of penetration through the filtration layer (the time to pass through the layer).

While a closed construction would filter out almost all particles, it would not be practical to breathe through. To maintain the hydrophobic outer layer properties, while having a hydrophilic layer right behind it, is challenging. One example of mask construction comprises a polyester outer layer, a hydrophilic middle media layer and a polypropylene hydrophobic polymer outer layer. To maintain a consistent distance between the outer layer and the media layer, the two layers are bonded together with another hydrophobic polyethylene polymer. Spunfab® polyethylene with very open three dimensional structure is used to maintain the highest breath-ability.

By layering a hydrophobic 3D web (thick, but open) a gap is created to the hydrophilic media layer. The higher basis weight but thicker and more open structure can maintain the beneficial hydrophobic structure on the outside, while allowing the creative construction of the most hydrophilic structure as media. This is advantageous as it increases overall surface area. Flow enhancement for filtration efficiency could apply to other aspects of filtration, other than a face mask.

An additional improvement on breathability comprises separating the media layer into lighter multiple layers, possibly electrically charged with layers of 3D web between to enhance air flow efficiency and distributing the air flow on an inhale cycle over a broader area. The 3D web in the middle may comprise a nonwoven, a spacer fabric, a knit or woven fabric, a 3D grid, or a micro pleated layer. This creates a gap to keep the media layers apart and distribute the inhalation over more of the filter area for more easy breathability, while maintaining filtration effectiveness. By decreasing the velocity concentration when the mask “hugs” the user's face on inhalation, by allowing it to spread over a broader area, the filter efficiency could increase by decreasing the air flow velocity while maintaining easier breathability. This construction advantageously provides the ability to make the multi-layer media in specific porosity layers, coarse to finer, or vice versa, depending on whether the goal is to protect the wearer or anyone in proximity.

Notwithstanding the forgoing, the protective barrier 100 can be any suitable size, shape, and configuration as is known in the art without affecting the overall concept of the invention, provided that it accomplishes the above stated objectives. One of ordinary skill in the art will appreciate that the shape and size of the protective barrier 100 and its various components, as show in the FIGS. are for illustrative purposes only, and that many other shapes and sizes of the protective barrier 100 are well within the scope of the present disclosure. Although dimensions of the protective barrier 100 and its components (i.e., length, width, and height) are important design parameters for good performance, the protective barrier 100 and its various components may be any shape or size that ensures optimal performance during use and/or that suits user need and/or preference. As such, the protective barrier 100 may be comprised of sizing/shaping that is appropriate and specific in regard to whatever the protective barrier 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A protective barrier comprising:
a filtration media structure comprising:
a first filtration media layer;
a second filtration media layer;
a channeling layer comprising a plurality of filaments arranged in a three-dimensional (3D) structure and sandwiched between the first and second filtration media layers.

2. The protective barrier of claim 1, wherein the 3D structure is an open fiber structure.

3. The protective barrier of claim 1, wherein the 3D structure is an extruded 3D mesh or is pleated.

4. The protective barrier of claim 1 further comprising an antimicrobial additive.

5. The protective barrier of claim 1, wherein the channeling layer is configured to disturb laminar airflow through the protective barrier.

6. The protective barrier of claim 1, wherein each filament has an increased surface area to weight ratio than a comparable filament having a round cross-section.

7. A protective barrier comprising:
a filtration media structure comprising:
an inner melt blown nonwoven filtration media layer;
an outer melt blown nonwoven filtration media layer;
a channeling layer comprising a plurality of filaments each having a non-round cross-section arranged in a three-dimensional (3D) structure and sandwiched between the inner and outer melt blown nonwoven filtration media layers.

8. The protective barrier of claim 7, wherein the inner and outer melt blown nonwoven filtration media layers have different weights.

9. The protective barrier of claim 7, wherein the outer melt blown nonwoven filtration media layer is heavier than the inner melt blown nonwoven filtration media layer.

10. The protective barrier of claim 7, wherein a basis weight of each of the inner and outer melt blown nonwoven filtration media layers ranges from 2 to 80 g/m².

11. The protective barrier of claim 7, wherein the channeling layer is configured to disturb laminar airflow through the protective barrier.

12. The protective barrier of claim 7, wherein each filament has an increased surface area to weight ratio than a comparable filament having a round cross-section.

13. The protective barrier of claim 7, wherein the channeling layer is electret treated.

14. The protective barrier of claim 7, wherein the channeling layer further comprises an antimicrobial additive attached to each filament.

15. The protective barrier of claim 14, wherein the antimicrobial additive comprises an antimicrobial effective amount of silver or copper.

16. A protective barrier comprising:
a barrier structure comprising a plurality of filaments each having a non-round cross-section arranged in a three-dimensional (3D) structure; and
an antimicrobial additive attached to the plurality of filaments.

17. The protective barrier of claim 16, wherein the barrier structure is electret treated.

18. The protective barrier of claim 16, wherein the barrier structure comprises an inner layer and an outer layer.

19. The protective barrier of claim 18 further comprising a media structure sandwiched between the inner and outer layers.

20. The protective barrier of claim 19, wherein the media structure comprises a first melt blown nonwoven media layer, a second melt blown nonwoven media layer, and a channeling layer sandwiched between the first and second melt blown nonwoven media layers.
